(19) United States
(12) Patent Application Publication
(10) Pub. No.: US 2009/0294652 A1
(43) Pub. Date: Dec. 3, 2009

(54) Electron Generation Apparatuses, Mass Spectrometry Instruments, Methods of Generating Electrons, and Mass Spectrometry Methods

(76) Inventors: Adam Keil, Lafayette, IN (US); Tri Le, West Lafayette, IN (US)

Correspondence Address: WELLS ST. JOHN P.S., 601 W. FIRST AVENUE, SUITE 1300, SPOKANE, WA, 99201, US

(21) Appl. No.: 12/475,185

(22) Filed: May 29, 2009

Related U.S. Application Data
(60) Provisional application No. 61/057,094, filed on May 29, 2008.

(51) Int. Cl. B01D 59/44; H01J 27/02

(52) U.S. Cl. 250/282; 250/423 R; 250/281

(57) ABSTRACT

Electron generation apparatuses are disclosed that can include a power source coupled to a first electrode, and a switch between the power source and the first electrode. Mass spectrometry instruments are disclosed that can include a power source coupled to a first electrode, and a switch between the power source and the first electrode. Methods of generating electrons are provided that can include generating different voltage differentials across a cell, with at least one of the voltage differentials generating electrons from gaseous material, and discharging at least some of the electrons from the cell. Mass spectrometry methods are also provided that can include providing sample proximate a glow discharge ionization source, and generating a pulse of electrons from the ionization source according to an ionization parameter to ionize at least a portion of the sample.

### CROSS REFERENCE TO RELATED APPLICATION

This application claims priority to U.S. provisional patent application Ser. No. 61/057,094 which was filed May 29, 2008, entitled “Analytical Instrumentation and Methods for Performing Instrumental Analysis”, the entirety of which is incorporated by reference herein.

### TECHNICAL FIELD

The present disclosure relates to analytical instruments and methods. Particular embodiments of the disclosure relate to instruments that utilize an ion source component such as mass spectrometry instruments.

### BACKGROUND

Electrons are generated for many purposes. At least one of these purposes is as part of an analytical method. An example analytical method that can utilize the generation of electrons is mass spectrometry. Typically, electrons are generated in mass spectrometry to bombard a sample and form ions that may be used to form other analyte ions or may be analyzed themselves. The present disclosure provides electron generation apparatuses, mass spectrometry instruments, methods of generating electrons, and mass spectrometry methods.

### BRIEF DESCRIPTION OF THE DRAWINGS

Preferred embodiments of the disclosure are described below with reference to the following accompanying drawings.

FIG. 1 depicts components of an analytical instrument according to an embodiment.

FIG. 2 depicts components of the analytical instrument of FIG. 1 according to an embodiment.

FIG. 3 depicts components of an analytical instrument according to an embodiment.

FIG. 4 is example data acquired utilizing instruments and methods according to an embodiment.

FIG. 5 is example data acquired utilizing instruments and methods according to an embodiment.

FIG. 6 is example data acquired utilizing instruments and methods according to an embodiment.

FIG. 7 is example data acquired utilizing instruments and methods according to an embodiment.

FIG. 8 is example data acquired utilizing instruments and methods according to an embodiment.

FIG. 9 is example data acquired utilizing instruments and methods according to an embodiment.

### SUMMARY

Electron generation apparatuses are disclosed that include first and second opposing electrodes separated by spacers, with the electrodes and spacers defining a cell having a volume. The apparatuses can also include a power source coupled to the first electrode, and a switch between the power source and the first electrode. The apparatuses can further include at least two orifices in fluid communication with the volume.

Mass spectrometry instruments are disclosed that can include a sample inlet component operatively engaging an analyte modification component, with the analyte modification component comprising an electron source component. The electron source component can include first and second opposing electrodes separated by spacers, a power source coupled to the first electrode, and a switch between the power source and the first electrode. The instruments can also include a mass separation component operatively engaging the analyte modification component, and a detection component operatively engaging the mass separation component.

Methods of generating electrons are provided that can include: providing gaseous material to within a cell; generating different voltage differentials across the cell, with at least one of the voltage differentials generating electrons from the gaseous material; and discharging at least some of the electrons from the cell.

Mass spectrometry methods are also provided that can include providing sample proximate a glow discharge ionization source; generating a pulse of electrons from the ionization source according to an ionization parameter to ionize at least a portion of the sample; separating ionized portions of the sample according to a mass separation parameter; and detecting the ionized portions to generate mass spectral data.

### DESCRIPTION

This disclosure is submitted in furtherance of the constitutional purposes of the U.S. Patent Laws “to promote the progress of science and useful arts” (Article 1, Section 8).

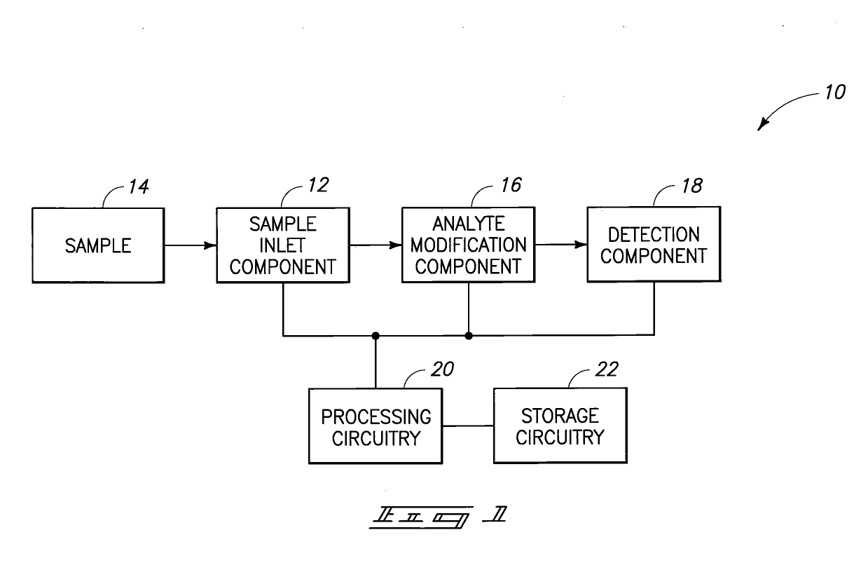

Referring to FIG. 1, an example instrument 10 according to an embodiment is shown that may include a sample inlet component 12 configured to receive the sample 14 and convey sample 14 to analyte modification component 16. Instrument 10 can also include a detection component 18 and processing circuitry 20 that may be coupled to one or more of sample inlet components 12, 16, 18 and/or storage circuitry 22. According to example implementations, instrument 10 can be configured as a mass spectrometry instrument that can include a sample inlet component operatively engaging an analyte modification component with the analyte modification component comprising an electron source component. Instrument 10 can further include a mass separation component operatively engaging the analyte modification component, and a detection component operatively engaging the mass separation component.

Sample inlet component 12 can be configured to introduce an amount of sample 14 into instrument 10 for analysis. Depending upon sample 14, sample inlet component 12 may be configured to prepare sample 14 for ionization. Types of sample inlets include batch inlets, direct probe inlets, chromatographic inlets, and permeable, semi-permeable, solid phase micro extractions (SPME) and/or capillary membrane inlets. Sample inlet component 12 can also be configured to prepare sample 14 for analysis in the gas, liquid and/or solid phase. Sample inlet component 12 can be configured to provide sample according to sample inlet parameters. In an example embodiment, sample inlet component 12 can be a chromatographic inlet and the sample inlet parameter of the chromatographic inlet can be a parameter that influences elution of sample 14 or portions of sample 14 from the chromatographic inlet. In one aspect, where the chromatographic inlet is a gas chromatographic inlet, an example sample inlet parameter can include the temperature value of a chromatography column of the gas chromatographic inlet. In some configurations, sample inlet component 12 may be combined with component 16.

Analyte modification component 16 can be configured to apply energy to portions of or all of sample 14. Application of this energy may ionize portions of sample 14 to create analytes that may be directed to detection component 18. Component 16 may also be configured to receive sample 14 directly or in other example embodiments to receive sample 14 from sample inlet component 12.

Component 16 can be configured to process/ionize sample 14 according to one or more parameters to form ionized analytes. Ionization parameters include parameters that affect one or more of the amount of ionization, dissociation, and/or fragmentation of sample 14 when exposed to component 16. In an embodiment component 16 can be configured to provide first and second ionization parameters. These parameters can include the providing electrons to sample 14 in one parameter and not providing electrons to sample 14 in another parameter. Configuring component 16 with these parameters in a repeating fashion can result in providing a pulse of electrons to sample 14. The formation of ionized analytes from sample 14 can include the bombardment of sample 14 with electrons, ions, molecules and/or photons. The formation of ionized analytes with ionization component 16 can also be performed by thermal or electrical energy according to the ionization parameter.

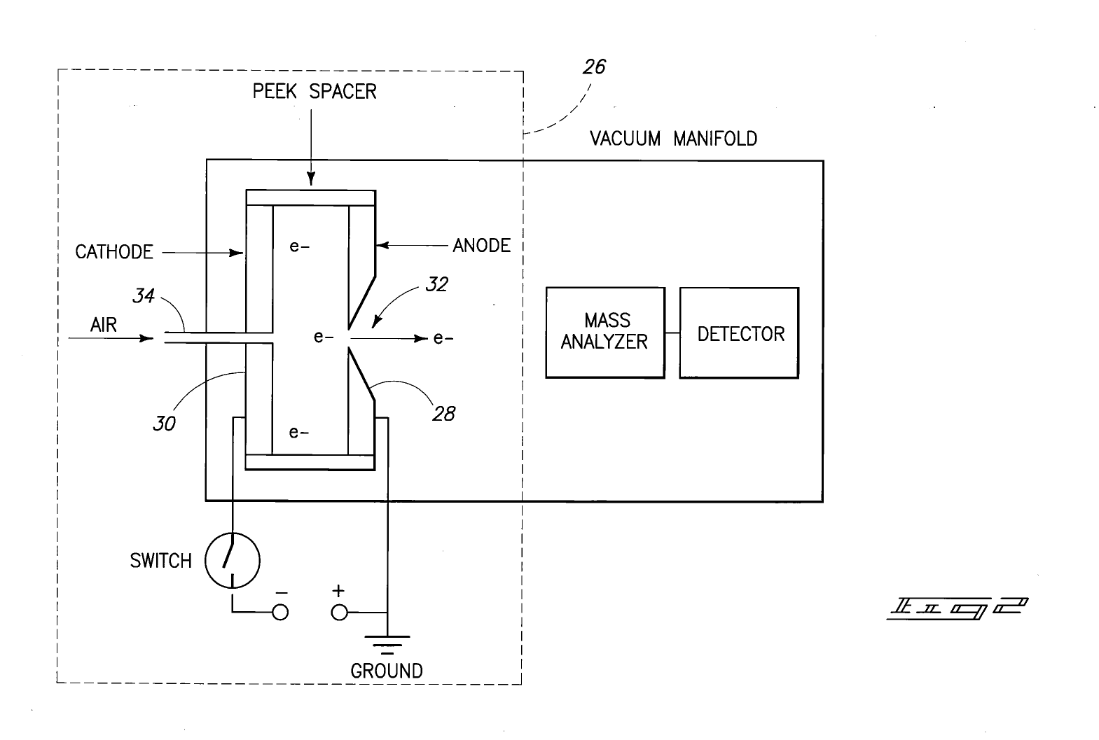

Component 16 can be configured as an electron source component. Component 16 may be configured to utilize, for example, a glow discharge cell such as the one depicted in FIG. 2 herein. According to other embodiments, instrument 10 can be configured with multiple electron and/or ion sources within component 16. For example, the glow discharge cell may be configured with a chemical ionization source as well.

Ionized analytes created in component 16 can be detected in detection component 18. Exemplary detection components include electron multipliers, Faraday cup collectors, photographic, and scintillation-type detectors. In an example embodiment, detection of these ionized analytes can indicate the characteristics of sample 14 referred to as sample characteristics. In one embodiment, sample characteristics can be acquired and correlated with respective ones of different value of a parameter (e.g., ionization parameter applied to the sample). At least one sample characteristic that can be recorded includes total ion current in one embodiment.

In one embodiment, the progression of analysis from component 12 through component 16 to component 18 can be controlled and/or monitored by processing circuitry 20. Processing circuitry 20 may be implemented as a processor or other structure configured to execute executable instructions including, for example, software and/or firmware instructions. Other exemplary embodiments of processing circuitry 20 include hardware logic, PGA, FPGA, ASIC, and/or other structures. These examples of processing circuitry 20 are for illustration and other configurations are possible.

Processing circuitry 20 can be configured to control the values of analytical component parameters described above and monitor detection component 18. Control of the analytical component values by processing circuitry 20 can include, for example, dictating a predefined application of ionization energy by component 16. In one embodiment, processing circuitry 20 can be configured to control component 16. In an exemplary aspect, processing circuitry 20 can dictate a value of an ionization parameter during a first moment in time and a different ionization parameter during a second moment in time. Example monitoring can include the recording of data received from detection component 18. By varying analytical component parameter values as described, sample characteristics can be obtained and associated with the parameter values and provided in the form of respective data sets according to the different values.

In one aspect, processing circuitry 20 may execute data acquisition and searching programming and be configured to perform data acquisition and searching that includes the acquisition of sample characteristics such as total ion current or mass spectra. In another aspect, processing circuitry 20 can be configured to associate detected sample characteristics such as total ion current responsive to one or more parameters such as ionization parameter including ion source energy. Processing circuitry 20 can be configured to monitor detection component 18 and associate detection of the first analytes with a first sample characteristic and detection of the second analytes with a second sample characteristic. Processing circuitry 20 may also be configured to associate both the first sample characteristic with the first value of the ionization parameter, and the second sample characteristic with the second value of the ionization parameter. In an example embodiment processing circuitry 20 can be configured to correlate both the first value of ionization parameter provided from component 16 with the ionized analytes detected during the first moment in time, and the second value of the ionization parameter provided from component 16 with the ionized analytes detected during the second moment in time. Processing circuitry 20 can also be configured to prepare a sample data set that may include first and second data sets corresponding to the respective values.

Processing circuitry 20 can be configured to store and access data from storage circuitry 22. Storage circuitry 22 is configured to store electronic data and/or programming such as executable instructions (e.g., software and/or firmware), data, or other digital information and may include processor-usable media. Processor-usable media includes any article of manufacture which can contain, store, or maintain programming, data and/or digital information for use by or in connection with an instruction execution system including processing circuitry in the exemplary embodiment. For example, exemplary processor-usable media may include any one of physical media such as electronic, magnetic, optical, electromagnetic, and infrared or semiconductor media. Some more specific examples of processor-usable media include, but are not limited to, a portable magnetic computer diskette, such as a floppy diskette, zip disk, hard drive, random access memory, read only memory, flash memory, cache memory, and/or other configurations capable of storing programming, data, or other digital information.

Storage circuitry 22 may store a plurality of data sets including first and second sets of data. In exemplary embodiments, the first set of data can include a plurality of sample characteristics obtained by a given value of a parameter as described above. The second set of data can include a plurality of a second sample characteristic obtained by a different value of the parameter as described above. As described above, these sample characteristics can include mass spectra and the parameter values which may be varied can include one or more of inlet, ionization, mass separation, and/or detection component parameters. In exemplary embodiments these data sets are associated by a sample. According to one aspect, the first and second sample characteristics can be of the same sample and according to an exemplary embodiment, the value of the acquisition parameters of the first set can be different than the acquisition parameters of the second set.

Referring to FIG. 2, analyte modification component 26 is shown. Component 26 can be an electron generation apparatus. The apparatus can include first and second opposing electrodes separated by spacers, with the electrodes and spacers defining a cell having a volume. The first electrode is configured as a cathode and the second electrode is configured as an anode, the one orifice extending through the anode. Component 26 can also include a power source coupled to the first electrode and a switch between the power source and the first electrode.

Component 26 can also have at least two orifices in fluid communication with the volume. One or both of the orifices can extend through one or both of the first and second electrodes. One orifice can extend through the first electrode and the other orifice can extend through the second electrode. In accordance with example implementations, one orifice can be aligned with the other orifice. At least one of the two orifices can include a tapered portion. The tapered portion can be proximate the exterior of the cell, for example.

Component 26 can be configured as a glow discharge cell with opposing plates 28 and 30. Plate 28 can be configured as an anode plate and plate 28 can have a faceted or tapered opening 32 therein to facilitate the discharge of electrons therefrom. Opening 32 can be configured as a small aperture having a diameter of a few hundred microns or from 250 μm to about 400 μm. Both plates can be affixed to an electrically and/or thermally insulative material with a cylindrical hole in the center to facilitate the transfer or generation of electrons. Two Viton O-rings may be used between the plates and the spacer to seal in component 26.

Plate 30 may be configured to receive gaseous material and/or establish a discharge. Such material can be air and/or helium, for example. Plate 30 can be configured with a Swagelok® and/or pneumatic fitting. Accordingly, plate 28 can be configured as an anode electrically connected to ground, and plate 30 can be configured as a cathode electrically connected via switch to a power source such as the high voltage power source controlled by process circuitry 50 described above. High voltage may be applied for several milliseconds during which electrons can exit component 26 through opening 32 and ionize theretofore neutral molecules such as portions of sample 14 described above.

A vacuum manifold encompassing at least component 26 can be provided. The manifold may also encompass at least the mass separation component and the detection component. The vacuum manifold may also be configured to encompass one or more of the electron source component, the mass separation component, and the detection component.

Parameters may be applied to component 26 such as analyte modification parameters including the programming of specific pulse techniques. The processing circuitry can be configured to provide an ionization parameter to the electron source component. The ionization parameter can dictate the generation of a pulse of electrons from the electron source component. For example, pulsing the high voltage for brief 1 to 100 millisecond periods can allow for the control of the number of analyte ions produced. Shorter pulse times may lead to the production of fewer analyte ions, while longer pulse times can lead to the production of larger numbers of analyte ions.

In accordance with example implementations component 26 can be rapidly switched on and off without the need of electrostatic lenses, and thus can reduce space, weight, and power associated with control circuitry to perform electron impact ionization in instruments such as the mass spectrometry instruments described herein. This can be an advantage over instruments that utilize high voltages in combination with electrostatic lenses to gate the electrons produced from metal filaments and prevent them from interacting with the portions of sample 14 to be ionized. When using these gating systems, the filament can be left on continuously, and rapidly turning the filament on and off can reduce the effective lifetimes due to the eventual mechanical failure.

Methods of generating electrons can include providing the gaseous material to within the cell and generating different voltage differentials across the cell. According to example implementations, at least one of the voltage differentials can generate electrons from the gaseous material. The method can further include discharging at least some of the electrons from the cell. In accordance with example embodiments, generating the different voltage differentials across the cell can be alternated. For example, one voltage differential can be provided and another of the voltage differentials can be substantially zero. The alternating can include cycling between the one differential generating ions and the other differential that is substantially zero. This cycling can be performed in accordance with an ionization parameter provided to an ionization component.

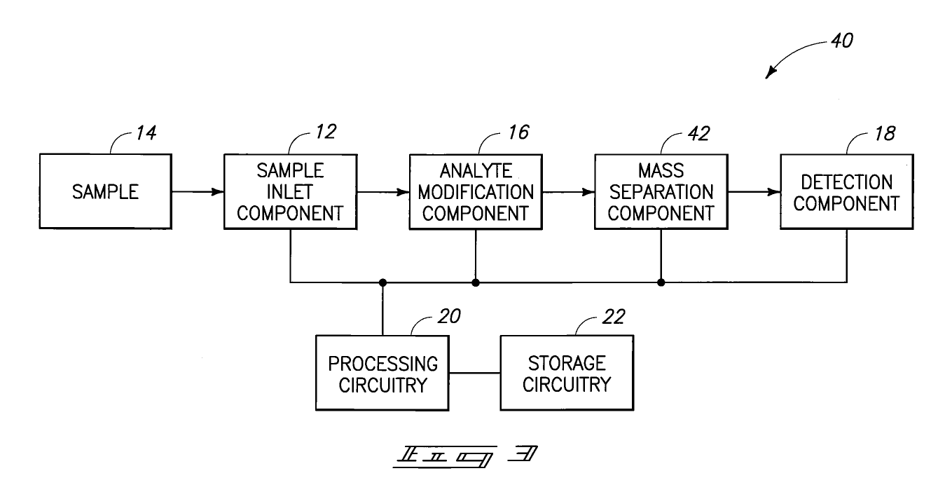

Referring to an example embodiment and with reference to FIG. 3, instrument 40 is disclosed that includes sample 14, components 12, 16, 18, and 22 previously described, but between components 16 and 18 lies mass separation component 42. Mass separation component 42 can be coupled to ionization component 16 and detection component 18. Instrument 40 includes processing circuitry 20 that can be coupled to mass separation component 42. As exemplified, processing circuitry 20 can be utilized to control mass separation component 42, and in an example embodiment, allow ionized analytes of a predetermined mass to charge ratio to proceed to detection component 18 for detection. Component 42 can include one or more of linear quadrupoles, triple quadrupoles, quadrupole ion traps (Paul), cylindrical ion traps, linear ion traps, rectilinear ion traps, ion cyclotron resonance, quadrupole ion traps, flight mass spectrometers, or other structures. Component 42 can also include focusing lenses as well as tandem mass separated components such as tandem ion traps and/or an ion trap and quadrupole ion trap in tandem.

Instrument 40 can be configured with both analyte modification parameters and mass separation parameters and these parameters can change utilizing process circuitry 20, for example. In one implementation utilizing component 26 of FIG. 2 in combination with a separation component such as separation component 42, at the initiation of ionization, high frequency radio potential can be applied to, for example, an ion trap that results in the trappings of ions. Prior to configuring component 42 with these parameters, component 26 can be in the ion emitting configuration, while the trap is not trapping any ions. Component 26 can be configured with parameters that allow for a 5 microsecond period of time in this emitting configuration which can be sufficient to provide for uniform electron production. Once the radio frequency is applied to separation component 42, created ions can be trapped in ionization time, and an ionization time period can begin. To end the ionization time period, component 26 can be turned to the off position, and the ionization can abruptly end.

As another example, component 26 can be applied to create ions from the effluent of a chromatography column. As described herein, inlet component 12 can be a chromatography column such as a gas chromatograph. As such, referring to the air inlet 34 of FIG. 2, the effluent from a chromatography column can be provided therein with the effluent having a mobile phase of either or both air and helium to establish a discharge. In accordance with other implementations, electrons can be emitted from the cell and these electrons can be used to ionize the effluent of the chromatography column, with this ionization occurring outside the discharge cell.

Utilizing instrument 40, for example, mass spectrometry methods can be performed with the methods including providing sample proximate a glow discharge ionization source; generating a pulse of electrons from the ionization source according to an ionization parameter to ionize at least a portion of the sample; separating ionized portions of the sample according to a mass separation parameter; and detecting the ionized portions to generate mass spectral data. In accordance with example implementations, the generating the pulse of electrons can include providing gaseous material to within a cell; generating different voltage differentials across the cell, at least one of the voltage differentials generating electrons from the gaseous material; and discharging at least some of the electrons from the cell.

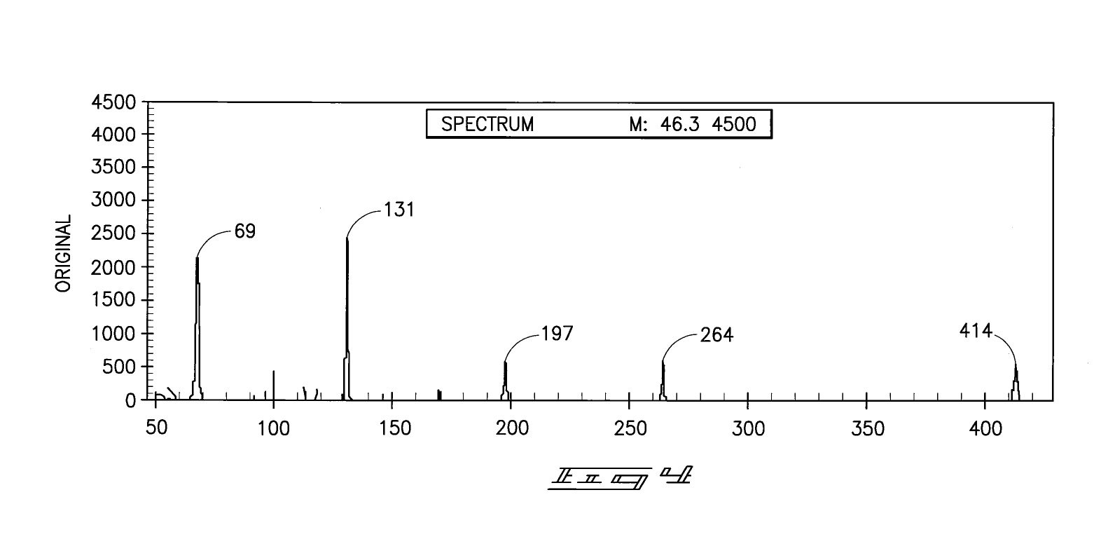

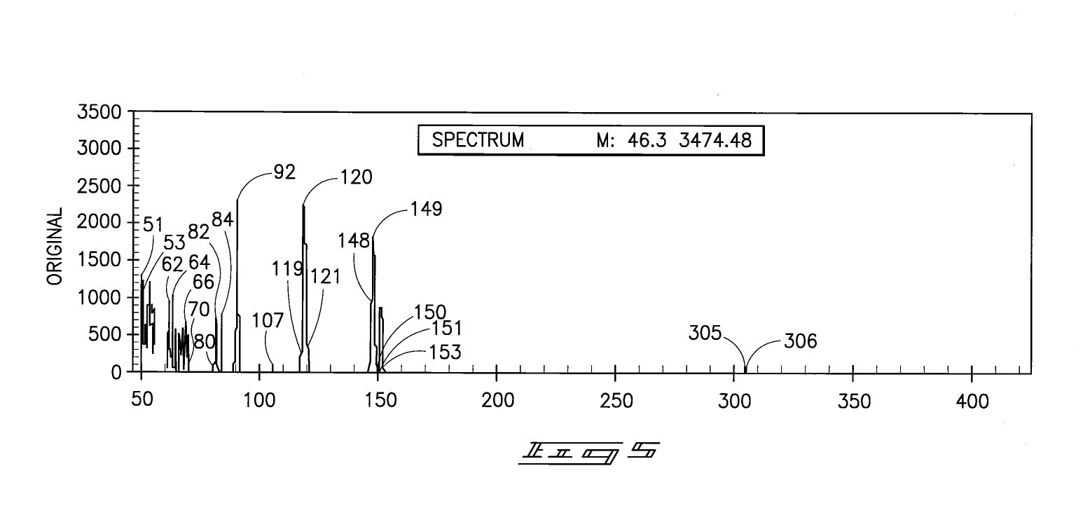

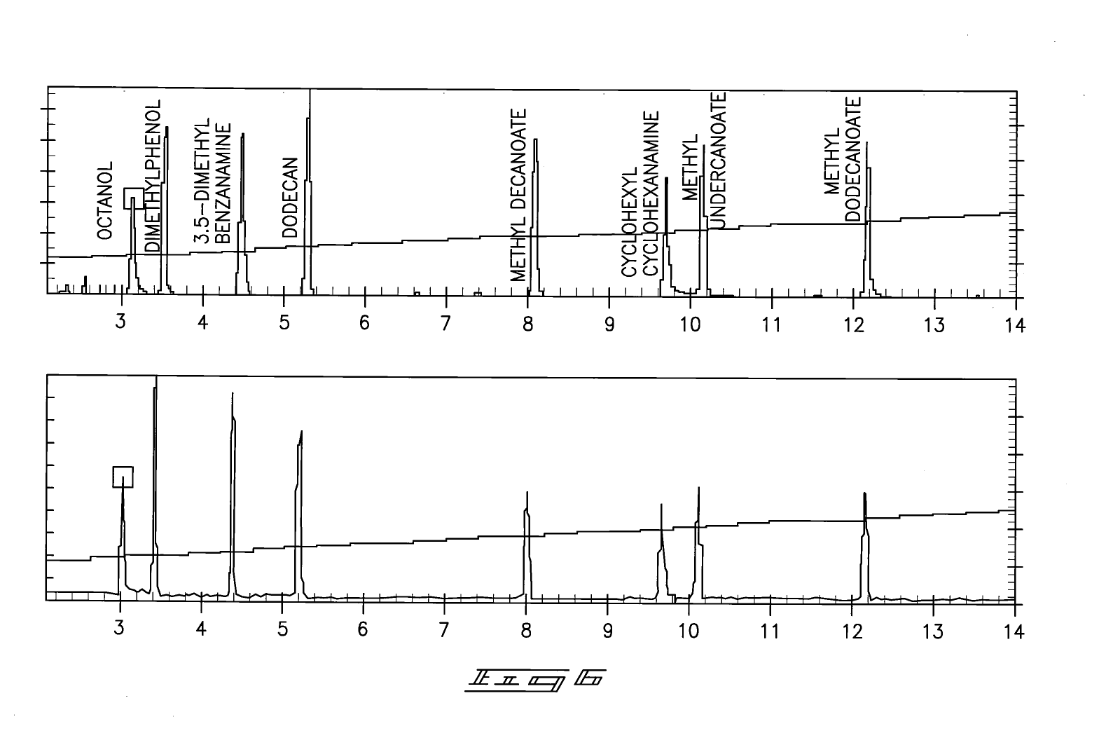

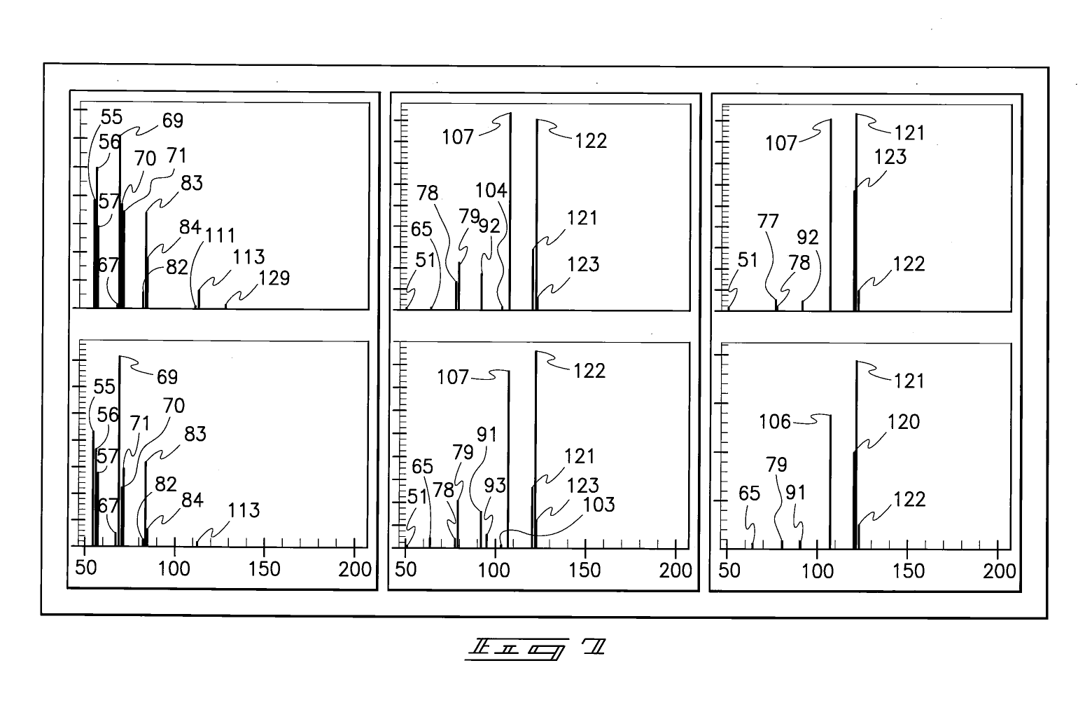

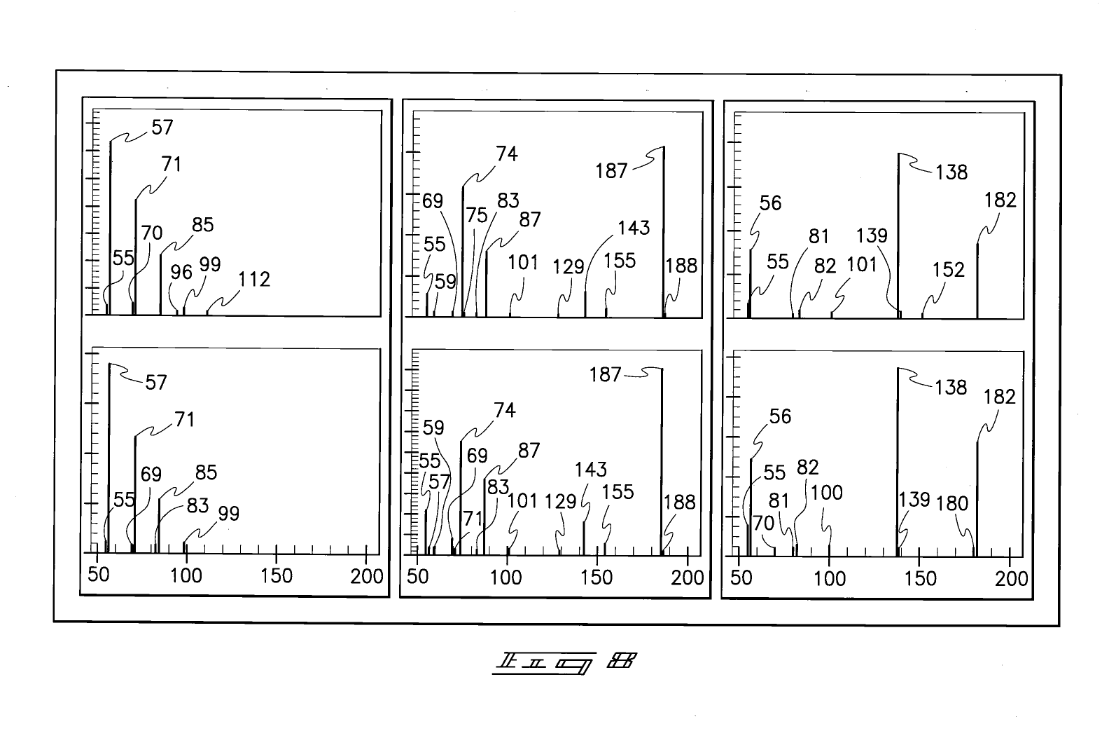

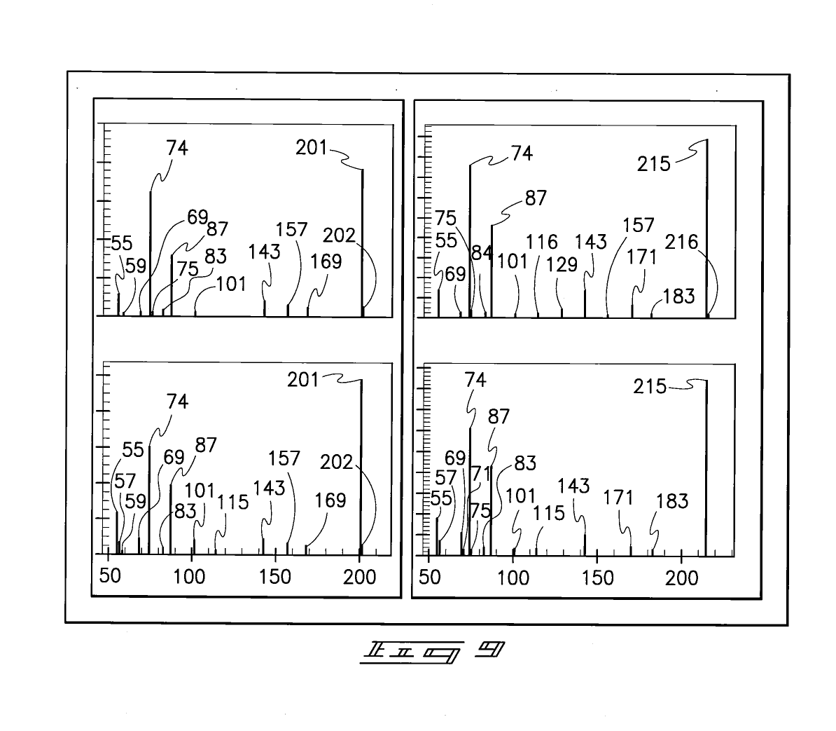

As seen below, with reference to FIGS. 4-9, example data can be acquired using component 26.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

1. An electron generation apparatus comprising:
first and second opposing electrodes separated by spacers, the electrodes and spacers defining a cell having a volume;
a power source coupled to the first electrode;
a switch between the power source and the first electrode; and
at least two orifices in fluid communication with the volume.

2. The apparatus of claim 1 wherein one or both of the orifices extend through one or both of the first and second electrodes.

3. The apparatus of claim 2 wherein one orifice extends through the first electrode and the other orifice extends through the second electrode.

4. The apparatus of claim 3 wherein the one orifice is aligned with the other orifice.

5. The apparatus of claim 1 wherein at least one of the two orifices comprises a tapered portion.

6. The apparatus of claim 5 wherein the tapered portion is proximate the exterior of the cell.

7. The apparatus of claim 6 wherein the first electrode is configured as a cathode and the second electrode is configured as an anode, the one orifice extending through the anode.

8. A mass spectrometry instrument comprising:
a sample inlet component operatively engaging an analyte modification component;
the analyte modification component comprising and electron source component, the electron source component comprising;
first and second opposing electrodes separated by spacers, the electrodes and spacers defining a cell having a volume;
a power source coupled to the first electrode;
a switch between the power source and the first electrode; and
at least two orifices in fluid communication with the volume;
a mass separation component operatively engaging the analyte modification component; and
a detection component operatively engaging the mass separation component.

9. The instrument of claim 8 further comprising a vacuum manifold encompassing at least the electron source component.

10. The instrument of claim 8 further comprising a vacuum manifold encompassing at least the mass separation component and the detection component.

11. The instrument of claim 8 further comprising a vacuum manifold encompassing one or more of the electron source component, the mass separation component, and the detection component.

12. The instrument of claim 8 further comprising one or both of processing circuitry and storage circuitry operably coupled to one or more of the components.

13. The instrument of claim 12 wherein the processing circuitry is configured to provide an ionization parameter to the electron source component, the ionization parameter dictating the generation of a pulse of electrons from the electron source component.

14. A method of generating electrons, the method comprising:
providing gaseous material to within a cell;
generating different voltage differentials across the cell, at least one of the voltage differentials generating electrons from the gaseous material; and
discharging at least some of the electrons from the cell.

15. The method of claim 14 further comprising alternating between generating the different voltage differentials across the cell.

16. The method of claim 15 wherein another of the voltage differentials is substantially zero.

17. The method of claim 16 wherein the alternating comprises cycling between the one differential generating electrons and the other differential that is substantially zero.

18. The method of claim 17 wherein the cycling is performed according to an ionization parameter.

19. A mass spectrometry method, the method comprising:
providing sample proximate a glow discharge ionization source;
generating a pulse of electrons from the ionization source according to an ionization parameter to ionize at least a portion of the sample;
separating ionized portions of the sample according to a mass separation parameter; and
detecting the ionized portions to generate mass spectral data.

20. The method of claim 19 wherein the generating the pulse of electrons comprises:
providing gaseous material to within a cell;
generating different voltage differentials across the cell, at least one of the voltage differentials generating electrons from the gaseous material; and
discharging at least some of the electrons from the cell.
